(19) United States
(12) Patent Application Publication
(10) Pub. No.: US 2010/0308134 A1
(43) Pub. Date: Dec. 9, 2010

(54) Automatic Paint Spray Gun For Two-Component Systems

(76) Inventor: Michael Bunnell, Plymouth, MI (US)

Correspondence Address: THE WEINTRAUB GROUP, P.L.C., 28580 Orchard Lake Road, Suite 140, Farmington Hills, MI, 48334, US

(21) Appl. No.: 12/791,224

(22) Filed: Jun. 1, 2010

Related U.S. Application Data
(60) Provisional application No. 61/183,603, filed on Jun. 3, 2009.

(51) Int. Cl. B05B 7/04

(52) U.S. Cl. 239/398

(57) ABSTRACT

A paint spray gun for two component paint systems for industrial applications and which may be an automatic gun for use with industrial robots or may be a hand held spray gun. The spray gun includes a housing or gun body having a tubular extension or forward end; a nozzle; a rotatable air cap mountable onto the tubular extension of the housing. The air cap has an air cap ring for threadably mounting the air cap to the gun body. A needle or needle valve is disposed within the gun body and a mixing chamber or packing is provided rearwardly of the nozzle in the tubular extension and in which the paint components are mixed. The tubular extension has a pair of opposed axially offset turbine air inlets in fluid communication therewith through which the paint components are delivered into the mixing chamber.

### CROSS-REFERENCE TO RELATED APPLICATION

This application is a completion application of co-pending U.S. Provisional Patent application, Ser. No. 61/183,603, filed Jun. 3, 2009, for “Paint Spray Gun,” the entire disclosure of which, including drawings, is hereby incorporated by reference.

### BACKGROUND OF THE INVENTION

1. Field of the Invention

The present invention pertains to paint spray guns. More particularly, the present invention and hand held actuated automatic spray guns pertains to fully automatic paint spray guns. Even more particularly, the present invention pertains to HVLP automatic paint spray guns for use with two-component paint systems.

2. Prior Art

In conventional paint spray guns, a stream of paint under pressure is discharged from a relatively small orifice in a nozzle while air under pressure is discharged radially inwardly into the stream from an annular opening surrounding the nozzle closely adjacent the paint discharge orifice to atomize the stream of paint into a spray of fine particles. The spray produced moves away from the gun in an expanding conical pattern whose apex is at the nozzle.

It is frequently desired to modify the circular cross-section of the normal conical spray pattern by transforming this pattern into one of a narrowed and elongated generally elliptically shaped cross-section so that the spray pattern more closely resembles that of a flat sided fan.

Conventionally, fanning of the spray pattern is accomplished by providing a pair of diametrically opposed ports or horns on the front of the air cap spaced radially outwardly from opposite sides of the annular air discharge opening. The diametrically opposed ports are oriented to direct air jets toward opposite sides of the spray pattern at a location spaced a short distance forwardly from the nozzle orifice. These jets have the effect of flattening the sides of the conical spray pattern against which they are directed. At any given distance from the nozzle, this action transforms the normally circular cross-section of the conical spray into a generally elliptically shaped cross-section. The major axis of the conical spray is somewhat greater than the original cone diameter, and the minor axis of the conical spray is somewhat less than the original cone diameter. The elliptical cross-section becomes flatter with an increase of the air pressure from the diametrically opposed fanning ports.

Conventionally, adjustment of the fanning of the paint spray is accomplished by either rotatably adjusting the air cap (turbine powered low pressure guns, i.e. HLVP guns) or through an adjustment valve (high pressure guns). A valve stem is adjusted by a thumb screw to restrict the flow of compressed air into a second passage connected to the fanning ports on the air cap. Conventional automatic guns have a separate air supply that can adjust the flow independent of the thumb screw. This adjustment exerts a valving action which establishes maximum air flow when the diametrically opposed valve ports lie in either a vertical plane containing the nozzle axis or a horizontal plane containing the nozzle axis. In a conventional gun, the flow through the fanning air ports may be reduced as the air cap is rotated, and the fanning air flow is cut off when the fanning air ports are midway between the horizontal and vertical positions referred to above. Alternately, the fanning air may be used just to control the paint pattern and the direction of the atomized paint.

The art is replete with teachings of various automatic paint spray guns as well as specific nozzles therefor addressing the topics discussed herewithin. For example, there exists U.S. Pat. No. 7,226,004; 6,854,667; 5,803,372; 5,707,010; 5,685,482; 5,322,221; 4,917,300; 4,660,774; 4,501,394 and 5,080,285 the disclosures of which are hereby incorporated by reference. While these aforementioned patents disclose eminently useful types of paint spray guns none are specifically directed to the deployment of such for use in two-component or two part paint systems.

### SUMMARY OF THE INVENTION

A spray gun in accordance with the present invention for industrial applications for use with industrial robots may be an automatic gun or may be a hand held spray gun. Regardless, spray gun hereof, generally, comprises a housing or gun body including a tubular extension or forward end; a nozzle; a rotatable air cap mountable onto the tubular extension of the housing, the air cap including; an air cap ring for threadably mounting the air cap to the gun body. The gun also includes a needle or needle valve disposed within the gun body and a mixing chamber or packing disposed rearwardly of the nozzle in the tubular extension and in which the paint components are mixed.

The tubular extension, which is integrally formed as part of the gun body, is a substantially cylindrical member having a pair of opposed axially offset turbine air inlets.

A pair of angularly offset inlets or injection inlets forward of the turbine air inlets, i.e. the fanning air and the atomizing air inlets. The offset inlets are offset, respectively, by an angle θ, which ranges from 10° to about 30° with respect to the horizontal or central longitudinal axis of the gun. A delivery passage is formed in each of the inlets or inlet ports. The inlet ports deliver the two part paint components for the two part paints, e.g. polyurethane paint, polyurea paints as well as other two part paints, e.g. catalyst and reactants and the like into the mixing chamber.

For a more complete understanding of the present invention, reference is made to the following Detailed Description and accompanying Drawing. In the Drawing, like reference characters refer to like parts throughout the several views, in which:

### BRIEF DESCRIPTION OF THE DRAWINGS

FIG. 1 is a side view of an HVLP automatic paint spray gun in accord herewith;,

FIG. 2 is a partial cross sectioned view of the nozzle portion of the gun hereof;

FIG. 3 is an end view of the gun hereof with the nozzle and air cap removed,

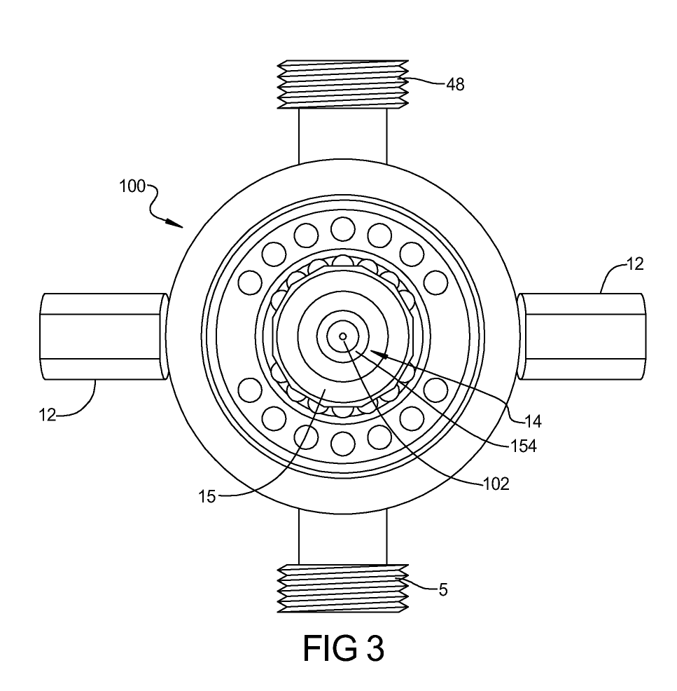

FIG. 4 is an end view of the gun hereof with the nozzle installed thereon.

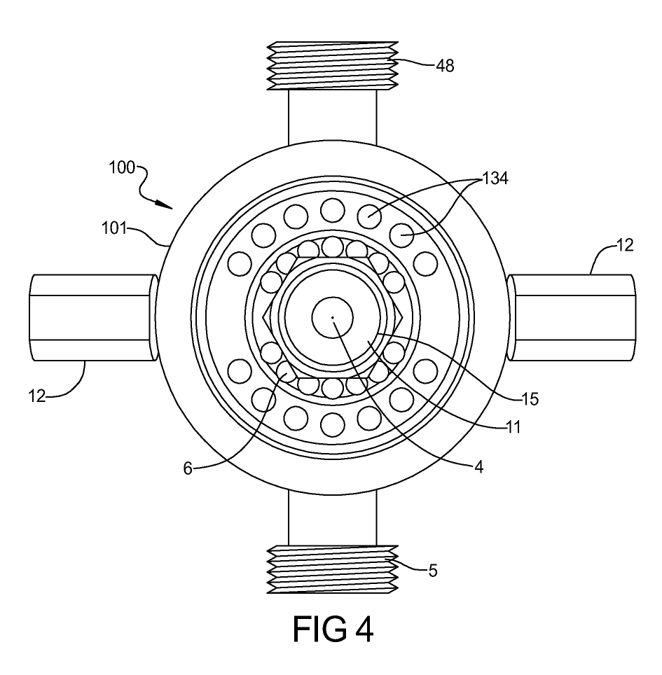

### DESCRIPTION OF THE PREFERRED EMBODIMENT

As disclosed hereinbelow, the present invention provides an HVLP automatic paint spray gun system which is specifically intended for use with two part paint systems, e.g. polyurethane paints, polyurea paints and the like.

The low pressure/high volume system of the present invention involves the use of turbine air for both atomizing air and fanning air. Turbine air is ordinarily supplied at less than 10 psi, whereas compressed air powered guns which are fed air from an air compressor is conventionally supplied at pressures of from 30-40 psi. Also, the turbine air is supplied to the paint spray gun at up to 36 cfm, whereas compressed air is supplied at flow rates from about 3 to about 20 cfm. Additionally, turbine air is supplied to the paint spray gun at temperatures of about 115° F. to about 185° F. higher than ambient temperature.

Another advantage of air supplied at lower pressures (turbine air) is that the atomizing air supplied to the paint spray is not as turbulent as high pressure compressed air resulting in an improved transfer efficiency of paint.

A low pressure/high volume system, such as that of the present invention results, in improved transfer efficiency of a paint spray gun. Transfer efficiency is defined as the ratio of the paint deposited on the product as compared with the paint used. The transfer efficiency of the paint spray gun of the subject invention is in the range of 65 to 90% on solid flat surfaces.

Now, and with more particularity and with reference to the drawing, there is depicted a spray gun in accordance with the present invention. The spray gun is intended for industrial applications and may be an automatic gun for use with industrial robots or may be a hand held spray gun. The spray gun hereof, generally, denoted at 100, comprises a housing or gun body 1 including a tubular extension or forward end 101; a nozzle 14; a rotable air cap 16 mountable onto the tubular extension of the housing including an air cap ring 17 for threadably mounting the air cap 16 to the gun body; a needle or needle valve 4 disposed within the gun body 1, and a mixing chamber or packing 11 disposed rearwardly of the nozzle 14 in the tubular extension 101 and in which the paint components are mixed.

As is known to the skilled artisan, paint is supplied to an article to be painted via a paint discharge central opening or orifice 102 provided in the nozzle 14. Typically, atomizing air impinges on the paint particles to atomize same. As shown herein, the valve is housed or disposed within a cavity or hollow 13. The cavity 13 is essentially an annular passage central of the tubular extension 101.

A passage or chamber 8 is formed in the tubular extension 10 through which fanning air is supplied to a plurality of fan discharge openings 6. The fanning air controls the fanning of the paint spray. The fanning air is preferably supplied to the paint spray gun from a different source than the atomizing air. However they may share the same source. The plurality of openings 6 are disposed radially outwardly from the cavity 13. The velocity of the fanning air increases as it passes through the plurality of openings 6.

The nozzle 14 is a stepped substantially circular flange 152 having a tapered interior (not shown) and which terminates in a reduced diameter, tapered conduit 154, the central orifice 102 of which is at the terminus thereof.

The nozzle 14 is maintained in position with respect to the tubular extension via a lock ring 15 which is threadably secured thereto.

The gun 100, also, includes first and second compressed air inlets 2 and 3 which open into chamber 136 and are used to control the position of the needle valve 4. As shown, the needle 4 is sealingly mounted to a piston 5 having an O-ring seal 36 disposed therearound to prevent the flow of air therepast. A lock nut 7 is used to secure the needle 4 to the piston 5.

The needle or needle valve 4 is mounted within the chamber 136 and is reciprocatingly movable through the use of the compressed air. The compressed air enters the chamber 136 through the inlet 2 to move the piston forwardly and, thus, the needle valve, to substantially seal the orifice 102. By introducing compressed air through inlet 3, the piston is moved rearwardly to retract the needle 4 and to open the orifice 102 to enable atomized air to be issued therethrough.

A threaded cap 10 seals the chamber 136 and through which the inlet 2 is formed. In other words as is known to those skilled in the art the needle reciprocates within the cavity or hollow 13 and the chamber 136.

A needle packing 8, as well as a packing nut 9, secure the needle 4 in position within the chamber 136. The needle construction is conventional within the prior art as disclosed and taught in the aforesaid patents.

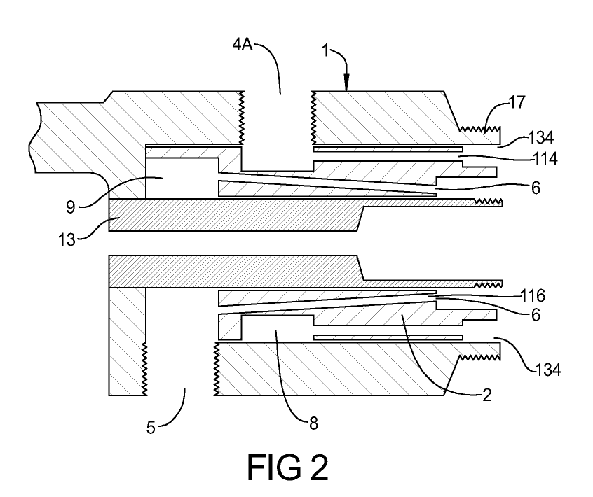

Referring particularly to FIG. 2, the tubular extension 101, which is integrally formed as part of the gun body 100, is a substantially cylindrical member having a pair of opposed axially offset turbine air inlets 4A and 5. The first inlet 4A is a fan air inlet and the second inlet 5 is an atomizing air inlet. Each of the inlets communicates with respective bores or passages 114, 116. A source or sources of turbine air (not shown) is/are in fluid communication with the inlets 114, 116.

The fan air bore 114 terminates in the plurality of circumferentially disposed fan air passage holes 151.

As noted above, the atomizing air passage or bore 116 terminates at the plurality of atomizing air passage holes 6 circumferentially disposed about the orifice 102. Typically, there are at least fourteen fan air passage holes or openings and an equal number of atomizing air passage holes.

The air cap 16, as noted above, is threadably attached to the nozzle 14 and is rotatably mounted thereon.

Angularly offset inlets or injection inlets or ports, both denoted by the numeral 12, are provided forward of the turbine air inlets, i.e. the fanning air and the atomizing air inlets 4A and 5. The offset inlets are offset, respectively, by an angle θ which ranges from about 10° to about 30° with respect to the horizontal or central longitudinal axis of the gun. A delivery passage 126, 125 is formed in each of the inlet ports 12, as shown. The inlet ports deliver the two part paint components for the two part paints, e.g. polyurethane paint, polyurea paints as well as other two part paints, e.g. catalyst and reactants and the like into the mixing chamber.

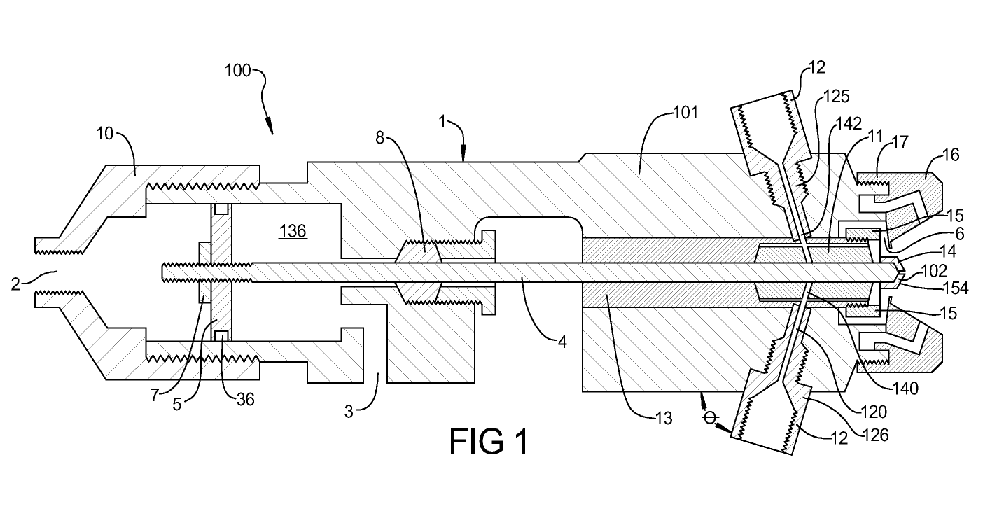

As shown in FIG. 1. the injection packing 11 is disposed within the cavity 13 and circumferentially disposed about the needle. The packing which is formed from any suitable material such as, nylon, Teflon or the like. The packing has openings 140, 142 which are, respectively, in fluid communication with associated delivery passages 126, 125 of the inlets 12.

The cylindrical nozzle packing 11 is disposed rearwardly of the nozzle 14 and about the needle valve 4. The packing 11 defines an internal mixing chamber for the paint components. The packing 11, being a substantially hollow cylindrical member, enables the intimate of intermixing of the two components of the paint to be sprayed because of the components being injected under pressure. The paint components are delivered under pressure to the packing through the pair of angularly disposed inlets 12 integrally formed with the gun body 100.

It is thus to be appreciated that in operation when the needle 4 is moved rearwardly of the openings 140, 142 the paint components are delivered to the internal mixing chamber of the packing 11 via the inlet ports 12.

In use, once the needle is retracted from the nozzle opening or orifice 102 and past the passages 125, 126 the paint components issue therethrough from the mixing chamber by the action of the atomizing air which pushes the paint through the orifice as the atomizing air, itself, passes through openings 138.

It should be noted that although any conventional source of turbine air may be used, so long as it is equal or exceeds the performance properties of the turbine generating the turbine air that is described in U.S. Pat. No. 4,925,368, the entire disclosure of which is hereby incorporated by reference including the entire text and drawings.

Furthermore, the actual nozzle to be used can be of any variety depending on the characteristics of the paint and the environment in which the paint is sprayed.

Having, thus, described the invention, what is claimed is:

1. A high volume low pressure paint spray gun for two component paints comprising:
(a) a housing including a tubular extension;;
(b) a nozzle;
(c) a rotatable air cap mountable onto the tubular extension of the housing including an air cap ring for threadably mounting the air cap to the housing;
(d) a needle disposed within the housing;
(e) a mixing chamber disposed rearwardly of the nozzle in the tubular extension and in which the paint components are mixed, and
(f) a pair of angularly offset inlets for delivering the paint components into the mixing chamber and in communication therewith.

2. The spray gun of claim 1, wherein:
the inlets are offset, respectively, by an angle θ, which ranges from 10° to about 30° with respect to the central longitudinal axis of the gun.

3. The spray gun of claim 1 which further comprises:
a paint discharge central opening provided in the nozzle for discharging atomizing air.

4. The spray gun of claim 1 which further comprises:
a turbine air source in fluid communication with the offset inlets.

5. The spray gun of claim 1 wherein:
each of the inlets has a delivery passage formed therein.

6. The spray gun of claim 1 which further comprises:
first and second compressed air inlets for controlling the position of the needle.

7. The spray gun of claim 5 wherein:
the mixing chamber is a synthetic resinous material, the chamber having openings which are, in fluid communication with an associated delivery passage of the inlets.

8. The spray gun of claim 1 wherein:
the tubular extension is integrally formed with the housing and is a substantially cylindrical member having a pair of turbine air inlets, a first inlet being a fan air inlet and the second inlet being an atomizing air inlet, the offset inlets being forward of the turbine air inlets.
